(19) United States
(12) Patent Application Publication
(10) Pub. No.: US 2009/0185395 A1
(43) Pub. Date: Jul. 23, 2009

(54) BACK-LIGHT MODULE

(75) Inventors: Che-Pin Hung, Hsinchu (TW); Hsueh-Jung Lu, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: FOXLINK IMAGE TECHNOLOGY CO., LTD., Hsinchu (TW)

(21) Appl. No.: 12/017,682

(22) Filed: Jan. 22, 2008

(51) Int. Cl. F21V 8/00; F21V 13/04

(52) U.S. Cl. 362/618; 362/621

(57) ABSTRACT

A back-light module includes a light-guiding plate and a light source. The light-guiding plate has a lateral inlet surface. The light source is arranged at one side of the lateral inlet surface. The light source has a plurality of light-emitting diodes which are disposed in a line and at interval. A gap is formed between the adjacent light-emitting diodes. The lateral inlet surface dispose a plurality of convex lenses, each of the convex lenses has a convex surface facing to the corresponding gap between the adjacent light-emitting diodes.

### BACKGROUND OF THE INVENTION

1. Field of the Invention

This present invention relates to a black-light module, and more specifically to a back-light module capable of producing light beams with even luminance.

2. The Related Art

Referring to FIGS. 1 and 2, a conventional back-light module 1 includes a light source 10, a reflection plate 11, a light-guiding plate 12, a diffusion sheet 13 and a brightness enhancement film 14. The light source 10 is composed of a plurality of light-emitting diodes (LEDs) 101 which are arrayed in a line and at certain intervals such that a gap is formed between each pair of the adjacent LEDs 101. The light-guiding plate 12 is approximately wedge-shaped and has a lateral inlet surface 121, a bottom surface 122 and an outlet surface 123. The light source 10 is arranged corresponding to the lateral inlet surface 121. The reflection plate 11 is arranged below the light-guiding plate 12 and parallels with the bottom surface 122. The diffusion sheet 13 and the brightness enhancement film 14 are sequentially disposed above the light-guiding plate 12 and parallel with the outlet surface 123. Rays from the LEDs 101 are projected into the inner of the light-guiding plate 12 via the lateral inlet surface 121, then reflected by bottom surface 122 and the reflection plate 11, and finally emitted from the outlet surface 123. The rays from the outlet surface 123 are diffused by the diffusion sheet 13 and then enhanced in brightness by the brightness enhancement film 14. Then the rays are projected into a Liquid Crystal Display (LCD) or a scanner to enable the LCD to display or the scanner to scan.

As best shown in FIG. 2, because the light source 10 is composed of several LEDs 101 and the luminance distribution characteristic of the LED 101 makes the luminance of areas of the light-guiding plate 12 facing to the gaps between the adjacent LEDs 101 weak while makes the luminance of areas of the light-guiding plate 12 facing to the LEDs 101 relatively strong, the luminance of the light-guiding plate 12 is not uniform, and even alternates between light and shade. This badly affects the display effect of the LCD or the scanner.

### SUMMARY OF THE INVENTION

An object of the invention is to provide a back-light module comprising a light-guiding plate and a light source. The light-guiding plate has a lateral inlet surface. The light source is arranged facing the lateral inlet surface. The light source has a plurality of light-emitting diodes which are arrayed in a line and at certain intervals. A gap is formed between each pair of the adjacent light-emitting diodes. A plurality of convex lenses are disposed on the lateral inlet surface, each of the convex lenses has a convex surface facing to the corresponding gap between the adjacent light-emitting diodes.

As described above, the convex lenses arranged in the lateral inlet surface focus rays to the area facing to the gap between the adjacent light-emitting diodes, so the luminance of the light-guiding plate is even, then the rays coming from the back-light module are even.

### BRIEF DESCRIPTION OF THE DRAWINGS

The invention, together with its objects and the advantages thereof may be best understood by reference to the following description taken in conjunction with the accompanying drawings, in which:

FIG. 1 is a schematic view of a conventional back-light module;

FIG. 2 is a schematic view showing an illuminating path via a light-guiding plate of the conventional back-light module;

FIG. 3 is a schematic view of a back-light module according to the present invention; and

FIG. 4 is a schematic view showing an illuminating path via a light-guiding plate of the back-light module.

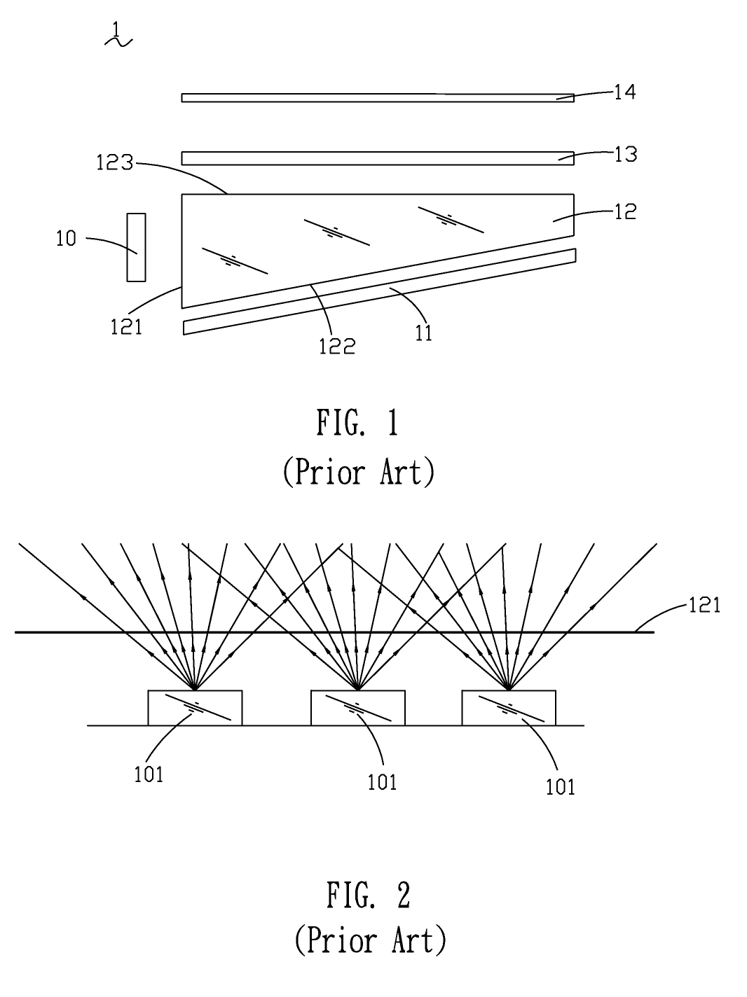

### DETAILED DESCRIPTION OF THE PREFERRED EMBODIMENT

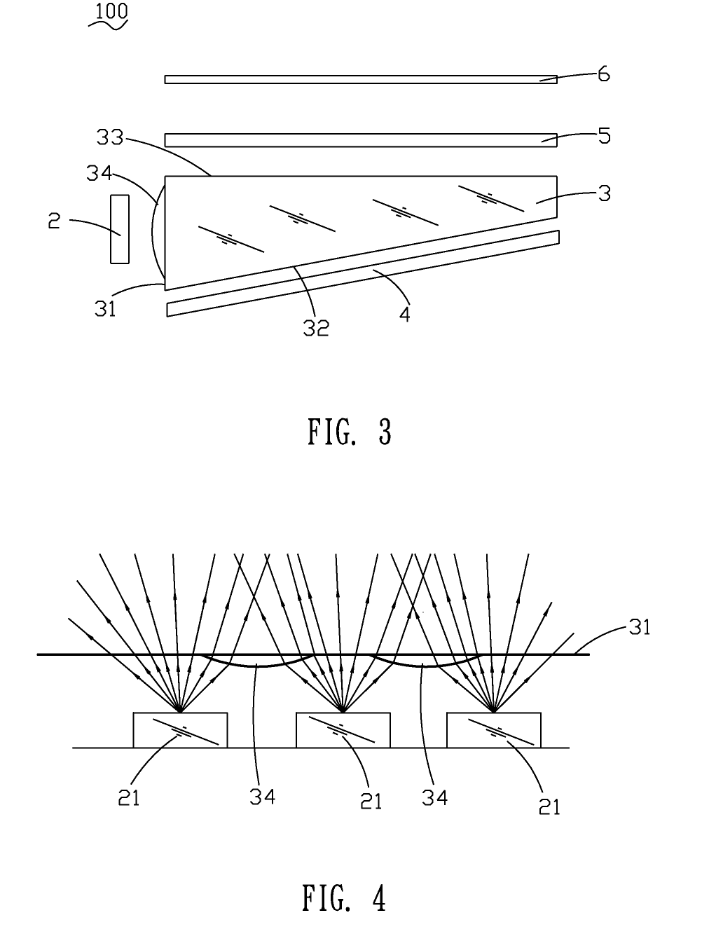

Referring to FIG. 3, a back-light module 100 according to the invention is shown. The back-light module 100 includes a light source 2, a reflection plate 4, a light-guiding plate 3, a diffusion sheet 5 and a brightness enhancement film 6.

In FIGS. 3 and 4, the light source 2 includes a plurality of light emitting diodes (LEDs) 21 disposed in a line and at interval, a gap is formed between the adjacent LEDs 21. The light-guiding plate 3 showing approximately a wedge shape has a lateral inlet surface 31, a bottom surface 32 and an outlet surface 33. The light source 2 is arranged at one side of the lateral inlet surface 31. The bottom surface 32 of the light-guiding plate 3 is an inclined plane, and an included angle formed between the lateral inlet surface 31 and the bottom surface 32 is an acute angle. The outlet surface 33 and the lateral inlet surface 31 are perpendicular to each other. The reflection plate 4 is arranged below the light-guiding plate 3 and parallels with the bottom surface 32. The diffusion sheet 5 and the brightness enhancement film 6 are sequentially disposed above the light-guiding plate 3 and parallel with the outlet surface 33. A plurality of convex lenses 34 are disposed on the lateral inlet surface 31. The convex lens 34 has a convex surface facing to the corresponding gap between the adjacent LEDs 21.

The rays from the LEDs 21 are projected into the inner of the light-guiding plate 3 via the later inlet surface 31. Because of the focus character of the convex lens 34, the convex lens 34 refracts and focuses the rays to an area facing to the gap between the adjacent LEDs 21, then the luminance of the area facing to the gap between the adjacent LEDs 21 is enhanced, the luminance of an area facing to the LED 21 is weaken because of the rays via the convex lenses 34 not projecting to the area facing to the LED 21. So the rays from the LEDs 21 are projected into the light-guiding plate 3 evenly. Part of the rays projected into the light-guiding plate 3 are reflected to the diffusion sheet 5 by the bottom surface 32, the other rays pass through the bottom surface 32 and then are reflected by the reflection plate 4 to the diffusion sheet 5. Lastly, the rays are projected on the brightness enhancement film 6 via the diffusion sheet 5. Then the rays are projected into a Liquid Crystal Display (LCD) or a scanner to achieve the LCD displaying or the scanner scanning.

According to the present invention, the convex lenses 34 arranged in the lateral inlet surface 31 focus the rays to the area facing to the gap between the adjacent LEDs 21, so the luminance of the light-guiding plate 3 is even, then the rays coming from the back-light module 100 are even.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. A back-light module, comprising:
a light-guiding plate having a lateral inlet surface; and
a light source arranged facing the lateral inlet surface, the light source having a plurality of light-emitting diodes arrayed in a line and at certain intervals, a gap being formed between each pair of the adjacent light-emitting diodes;
wherein a plurality of convex lenses are disposed on the lateral inlet surface, each of the convex lenses has a convex surface facing to the corresponding gap between the adjacent light-emitting diodes.

2. The back-light module as set forth in claim 1, further comprising a reflection plate, a diffusion sheet and a brightness enhancement film, wherein the light-guiding plate has a bottom surface in the bottom thereof and an outlet surface in the top thereof, the reflection plate is arranged below the light-guiding plate and parallels with the bottom surface, the diffusion sheet and the brightness enhancement film are sequentially stacked on the light-guiding plate and parallel with the outlet surface.

3. The back-light module as set forth in claim 2, wherein an included angle between the lateral inlet surface and the bottom surface is an acute angle, the outlet surface is perpendicular to the lateral inlet surface.
